(19) United States
(12) Patent Application Publication
(10) Pub. No.: US 2004/0089095 A1
(43) Pub. Date: May 13, 2004

(54) Bicycle handlebar with recesses for receiving brake cables

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/291,432

(22) Filed: Nov. 12, 2002

(51) Int. Cl. B62K 21/12

(52) U.S. Cl. 74/551.1

(57) ABSTRACT

A bicycle handlebar assembly includes two brake levers connected thereto and each brake lever has two brake cables extending therefrom. The handlebar includes a bar connected to the handlebar stem and has two recesses defined in an outer surface thereof. Each recess includes two entrances which extend at angle relative to an axial direction of the recess. Each of the entrances is a plain surface. The recesses and the entrances receive the brake cables so that the brake cables do not protrude from the outer periphery of the bar.

### FIELD OF THE INVENTION

The present invention relates to a bicycle handlebar that has recesses for receiving brake cables and each recess includes an entrance at two ends thereof so that the brake cables are smoothly engaged with the handlebar.

### BACKGROUND OF THE INVENTION

A conventional bicycle handlebar 100, especially for the handlebar of mountain bikes which are operated on serrated roads, includes two brake levers 110 connected on two ends of the handlebar 100, as shown in FIGS. 9 to 12. Each brake lever 110 has two brake cables 130 connected therefrom and extended to the brake mechanism of the front wheel and the rear wheel. In order not to be tangled by objects during riding the bicycles, the brake cables 130 are engaged with grooves 120 defined in an outer periphery of the handlebar 100. Nevertheless, the V-shaped grooves 120 reduce the structural strength of the handlebar 100 so that the handlebar 100 could be broken at the positions where the grooves 120 are defined. The brake cables 130 protrude from the surface of the handlebar 100 at the conjunction portion of the grooves 120 and the outer periphery of the handlebar 100 where no grooves 120 are defined. The protrusion of the brake cables 130 makes the grasp of the user's hand feel uncomfortable when the hands grasp on the top bar portion 140 of the handlebar 100.

The present invention intends to provide a bicycle handlebar that has recesses defined in an outer periphery of the handlebar and each recess includes two entrances such that the brake cables are smoothly connected to the handlebar without protruding from the outer periphery of the handlebar.

### SUMMARY OF THE INVENTION

In accordance with one aspect of the present invention, there is provided a bicycle handlebar assembly which includes two brake levers connected thereto and each brake lever has two brake cables extending therefrom. The handlebar comprises a bar which has two recesses defined in an outer surface thereof and each recess includes two entrances which extend at angle relative to an axial direction of the recess. Each of the entrances is a plain surface and the recesses and the entrances receive the brake cables.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle handlebar of the present invention;

FIG. 2 shows the recess defined in an outer periphery of the bicycle handlebar of the present invention;

FIG. 3 is a cross sectional view to show the brake cables engaged with the entrances of the recesses;

FIG. 4 shows a band wrapping around the handlebar and the brake cables;

FIG. 5 illustrates the cross section of the handlebar that has the recess;

FIG. 6 shows a side view of the brake cables engaged with the recesses;

FIG. 7 is a perspective view to show the handlebar and the brake cables of the present invention;

FIG. 8 is a perspective view to show the handlebar and the brake cables are wrapped by a band;

FIG. 9 is a perspective view to show a conventional bicycle handlebar and the brake cables engaged with the grooves in the conventional handlebar;

FIG. 10 is a side view to show the brake cables engaged with the grooves in the conventional the handlebar;

FIGS. 11 and 12 show the brake cable engaged with the grooves in the conventional the handlebar.

### DETAILED DESCRIPTION OF THE PREFERRED EMBODIMENT

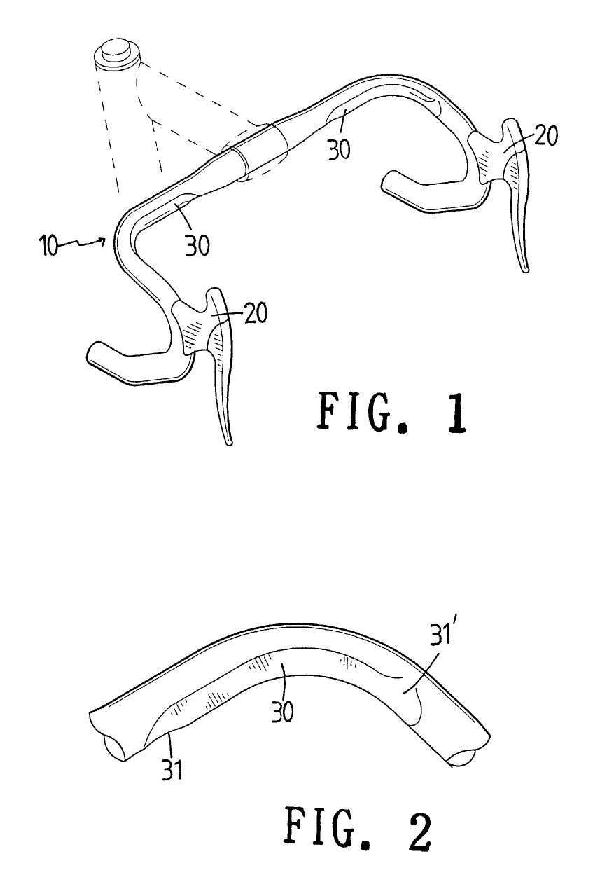

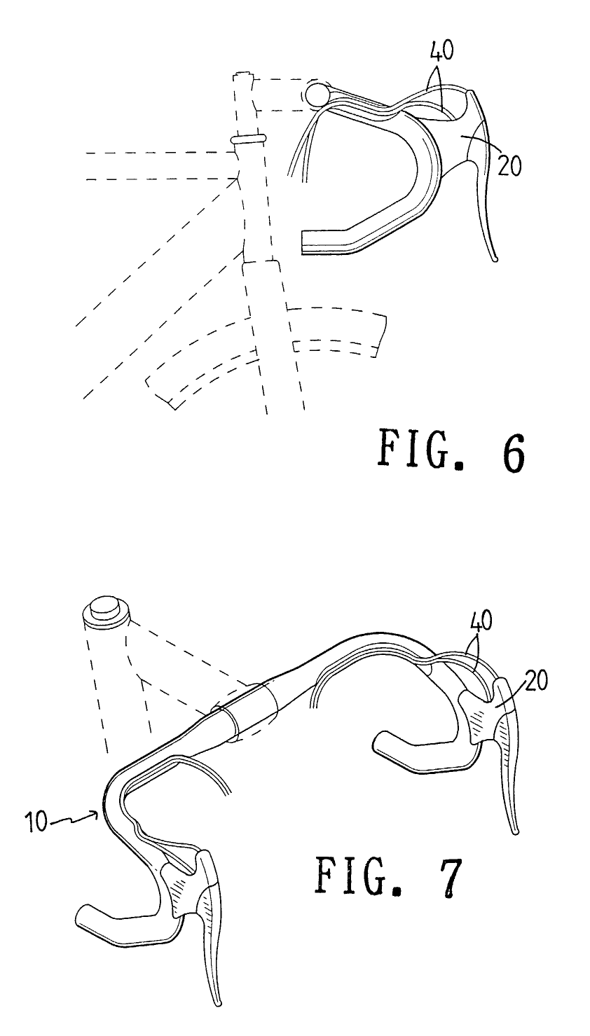

Referring to FIGS. 1, 2, 3, 5, 6 and 7, the bicycle handlebar assembly of the present invention comprises a bar 10 which is connected to a handlebar stem and the handlebar stem is connected to a steerer tube such that when operating the bar 10 the front wheel turns with the steerer tube.

Two brake levers 20 are connected to tow ends of the bar 10 and each brake lever 20 has two brake cables 40 extending therefrom which are extended and connected to the front wheel brake mechanism (not shown) and the rear wheel brake mechanism (not shown).

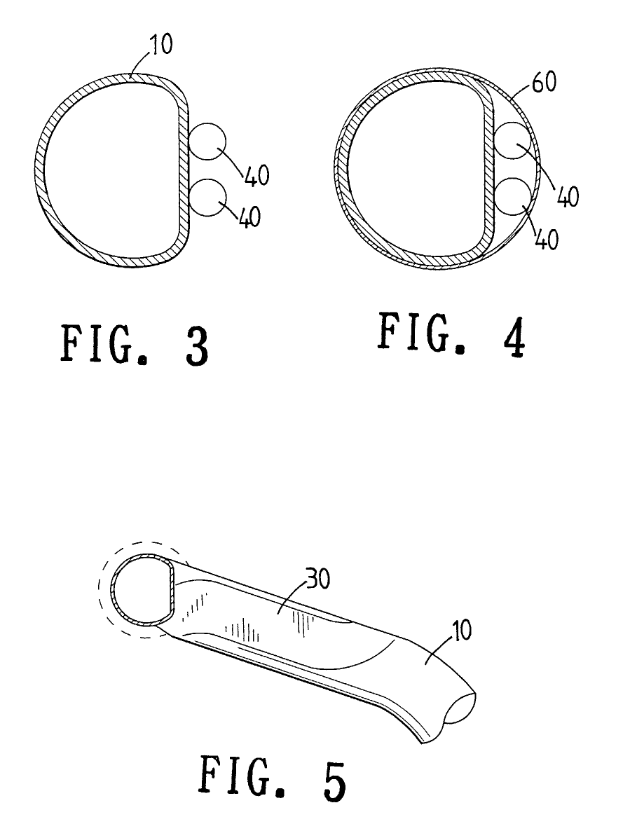

The bar 10 has two recesses 30 defined in an outer surface thereof and each recess 30 includes two entrances 31, 31′ which are plain surfaces and extend at angle relative to an axial direction of the recess 30. The entrances 31, 31′ and the recesses 30 receive the brake cables 40. It is to be noted that the brake cables 40 enter the recesses 30 via the entrances 31, 31′ and do not protrude beyond the contour of the outer periphery of the bar 10 as shown in FIG. 3.

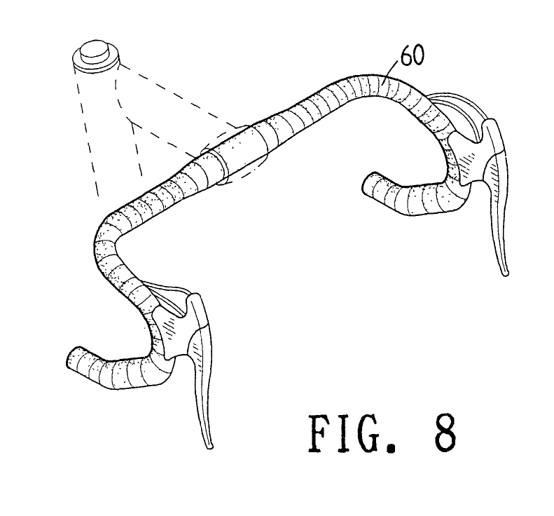

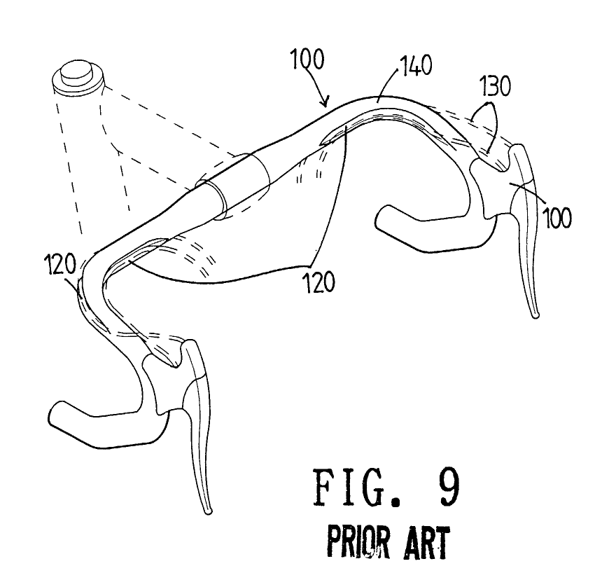

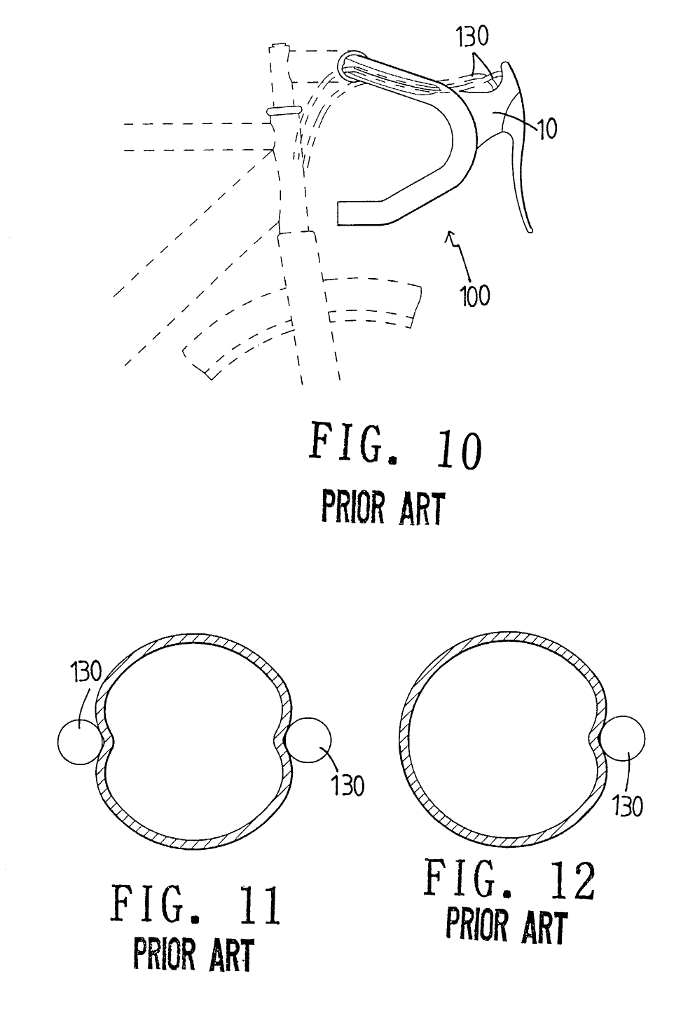

As shown in FIGS. 4 and 8, a band 60 is then used to wrap around the bar 10 and the brake cables 40 as shown in FIG. 8 and the outer contour of the final result of the handlebar assembly has a circular cross section as shown in FIG. 4 such that when the rider grasps the handlebar assembly, no protrusion is felt and is comfortable even if the hand has to grasp the bar 10 for a long period of time.

While we have shown and described the embodiment in accordance with the present invention, it should be clear to those skilled in the art that further embodiments may be made without departing from the scope of the present invention.

What is claimed is:

1. A bicycle handlebar assembly includes two brake levers connected thereto and each brake lever having two brake cables extending therefrom, the handlebar comprising:
a bar having two recesses defined in an outer surface thereof and each recess including two entrances which extend at angle relative to an axial direction of the recess, each of the entrances being a plain surface, the recesses and the entrances adapted to receive the brake cables.
